(19) United States
(12) Patent Application Publication
(10) Pub. No.: US 2013/0086917 A1
(43) Pub. Date: Apr. 11, 2013

(54) APPARATUS FOR HEAD END DIRECT AIR INJECTION WITH ENHANCED MIXING CAPABILITIES

(71) Applicants: Ilya Aleksandrovich Slobodyanskiy, Greenville, SC (US); Gilbert Otto Kraemer, Greenville, SC (US); Leonid Yul'evich Ginesin, Moscow (RU); Dmitry Vladlenovich Tretyakov, Moscow (RU); Andrey Pavlovich Subbota, Moscow (RU)

(72) Inventors: Ilya Aleksandrovich Slobodyanskiy, Greenville, SC (US); Gilbert Otto Kraemer, Greenville, SC (US); Leonid Yul'evich Ginesin, Moscow (RU); Dmitry Vladlenovich Tretyakov, Moscow (RU); Andrey Pavlovich Subbota, Moscow (RU)

(21) Appl. No.: 13/253,997

(22) Filed: Oct. 6, 2011

(51) Int. Cl. F02C 9/00

(52) U.S. Cl. 60/773; 60/39.27

(57) ABSTRACT

A method for reducing the amount of carbon monoxide and oxygen emissions in a hydrocarbon combustor in a gas turbine engine by feeding hydrocarbon fuel and an oxidizer component into the head end of the combustor while also injecting substantially inert gas into the combustor with the fuel and oxidizer; forming a combustor exhaust stream that mixes with the recycle; cooling the combustor exhaust; detecting the amount of carbon monoxide and oxygen in the exhaust and adjusting the amount of fuel, oxidizer and inert gas feeds based on the detected amounts.

### BACKGROUND OF THE INVENTION

The present invention relates to a combustion system for gas turbine engines and, more particularly, to an improved combustor design and method for using direct air injection and a substantially inert gas feed such as an exhaust gas recycle stream (“EGR”) as the primary working fluid. (The terms “inert gas stream” and “substantially inert gas stream” are used interchangeably herein to refer to an EGR type gas stream having small, residual amounts of oxygen). The method and apparatus according to the invention reduce the formation of undesirable gas emissions from the gas turbine engine while increasing the overall efficiency of the combustor.

Gas turbine engines typically include a compressor section, a combustor section and a turbine that rotates to generate electrical power. The compressor discharges higher pressure gas directly into the combustor where hydrocarbon fuel is injected, mixed and burned to produce thermal and kinetic energy. The combustion gases are then channeled into and through one or more stages of the turbine which extracts rotational energy from the exhaust gases with the rotational energy then being used to generate electrical power. Most existing gas turbine engines include multiple combustors positioned circumferentially around a rotational axis. In order to achieve maximum operating efficiency, the combustors operate over a wide range of different fuel compositions, pressures, temperatures and fuel/air ratios, preferably with the ability to use either liquid or gas fuels. Most gas turbine engines also tend to operate in a slightly “rich” mode, i.e., with less than the precise stoichiometric amount of oxygen in the feed necessary to burn the entire hydrocarbon fuel mixture, resulting in at least some incomplete combustion, and hence the production of carbon monoxide and other by-products.

In most systems, the combustion exhaust invariably contains small amounts of excess CO and oxygen, with some CO₂ disassociating into CO and O₂, depending on the specific combustor operating conditions. Unless removed, the same components, including the residual amount of oxygen, remain in the system as they pass into and through components downstream of the combustor, e.g., the turbine and heat recovery steam generator. As a result, the final exhaust stream from conventional gas turbine engines includes N₂ and CO₂ with small amounts of CO, O₂ and oxides of nitrogen, all of which eventually must be removed or reacted in downstream operations (such as by catalyst treatment) in order to maintain desired gas turbine efficiencies.

The need for combustors with improved emissions is a direct outgrowth of air pollution concerns resulting from more stringent domestic and international pollution control standards such as those promulgated by the Environmental Protection Agency regulating the release of oxides of nitrogen, unburned hydrocarbons and carbon monoxide. The unwanted emissions generally fall into two broad categories—those resulting from high flame temperatures (e.g., NOₓ) and those formed at lower flame temperatures, such as CO, that do not allow the basic fuel-air reaction to proceed to completion. Operating at low combustion temperatures in order to lower the NOₓ emissions can result in incomplete or partially incomplete combustion, which in turn leads to the production of excessive amounts of unburned hydrocarbons and carbon monoxide, as well as lower power output and lower thermal efficiency of the engine. Higher combustion temperatures, on the other hand, tend to improve thermal efficiency and lower the amount of unburned hydrocarbons and CO, but can still result in a higher amount of NOₓ if the combustion mixture and operating conditions are not properly monitored and controlled.

Two additional practical concerns influence the need to control the amount of unwanted emissions formed in the turbine exhaust. First, the fuel to air ratio is subject to finite control since only a limited ability exists to control the exact amount of fuel being fed to each combustor in a multi-combustor design. Second, individual combustors tend to operate with a slightly different fuel to air ratio, resulting in variations in the emissions on a “can-to-can” basis. As noted, in the past those design issues have contributed to the need to operate gas turbine engines with a slight amount of excess fuel with all (or virtually all) of the oxygen present in the exhaust eventually being consumed and/or eliminated using catalyst treatment. However, it has been difficult to control the exact amount of CO produced during the initial combustion, particularly on an individual combustor basis.

While numerous combustor designs have been proposed over the years to enhance the mixing of fuel and air prior to combustion, the need remains for improvements in combustor architecture in order to reduce the level of undesirable components such as NOₓ formed when the flame temperatures occasionally become too high or when the combustion is incomplete leaving residual oxygen and CO in the exhaust. Thus, the industry continues to search for pre-combustion systems that provide improved fuel/air mixing upstream of the combustor and better thermal efficiency, but with reduced NOₓ and unburned hydrocarbon emissions during and after combustion takes place.

The present invention addresses the above concerns by providing a new method for reducing and controlling the CO and oxygen emissions in a gas turbine combustor using a hydrocarbon fuel that is burned with an oxidizer such as air or “oxyfuel.” Significantly, the invention includes the use of a significant volume of a low to near zero oxygen content gas, such as the exhaust gas recycle (“EGR”) from the gas turbine engine as a major part of the working fluid. The use of an inert combustor feed offers particular advantages for applications in which the gas turbine system is designed to achieve stoichiometric exhaust gas recirculation in order to reach target emissions goals. As detailed below, it has been found that the combustion dynamics can be significantly improved by changing the nature and composition of the primary working fluid and the manner in which it is fed to the combustor head end prior to ignition, resulting in improved emissions (less oxygen and CO formed during combustion) without sacrificing engine efficiency.

### BRIEF DESCRIPTION OF THE INVENTION

The invention described below includes a new method for reducing the amount of carbon monoxide and oxygen emissions in a hydrocarbon combustor in a gas turbine engine using the following basic steps: feeding hydrocarbon fuel and an oxidizer component (such as air) directly into the head end of the combustor while injecting defined amounts of a substantially inert gas (nominally an exhaust gas recycle or “EGR”) directly into the combustor head with the fuel and oxidizer; igniting the fuel mixture to form a combustor exhaust stream that includes EGR; cooling the combustor exhaust using a portion of the same EGR circulated around the combustor shell and then exhausted from the system; detecting the amount of carbon monoxide and oxygen present in the combustor exhaust; and adjusting the amount of fuel, oxidizer and inert gas feeds based on the detected amount of carbon monoxide and oxygen.

The invention can be incorporated into a gas turbine engine comprising a gas compressor, one or more combustors as described above, a turbine driven by the expanded exhaust from the combustors, a primary fuel circuit for the combustors that feeds hydrocarbon fuel and air to each combustor, means for feeding the substantially inert gas stream into each combustor, carbon monoxide and oxygen sensors disposed in the exhaust stream, and a control for determining the amount of fuel, air and substantially inert gas stream to be fed to each combustor based on the detected amount of carbon monoxide and oxygen.

The invention thus includes both a method and combustor architecture that uses direct air injection into the head end of the combustor in combination with an inert feed, namely a very low oxygen-content gas recycle stream as the working fluid. In an exemplary embodiment, both the external air and a portion of the gas turbine exhaust (having little or no oxygen present and reduced in temperature) are combined to form the primary working fluid after the combustor reaches a desired level of operation following startup. The lower temperature inert gas stream (comprising mostly nitrogen and CO₂) serves to improve the stoichiometry of the combustion while acting as a cooling medium for the combustor itself.

The method as described below in connection with FIGS. 1-6 includes two principal modes of operation: (a) the use of a primary working fluid comprising air and an inert exhaust gas recycle stream in an amount up to about 50% by volume of the total feed to the combustor, with the EGR stream being supplied to the combustor from a gas turbine compressor; and (b) the use of the same substantially inert gas (EGR) as a coolant for the hot section of the combustor and to help control the combustor flame temperature.

As noted above, the new combustor design and related method are capable of supporting stoichiometric combustion with minimum resulting O₂ and CO emissions. The amount of NOₓ and CO emissions can also be adjusted by an additional diluent injection (such as nitrogen) directly into the combustor head end. In addition, the combustor nozzle designs described below for use with the head end result in improved mixing of the fuel, air and EGR before the mixture is injected into the combustor. The invention also includes an integrated fuel and air combustion system for a gas turbine engine comprising one or more combustors, a modified fuel supply for providing hydrocarbon fuel to the combustors, a compressed external air supply for the combustor (such as that generated by a main air compressor), means for providing the inert exhaust gas recycle stream to the combustor and a modified fuel and air nozzle positioned in the head end of the combustor for providing the desired mixing of components prior to ignition.

### BRIEF DESCRIPTION OF THE DRAWINGS

FIG. 1 is a process flow diagram of an exemplary gas turbine engine illustrating the basic components and process steps for performing the method according to the invention using the new combustor design;

FIG. 2 is a cross-section of an exemplary embodiment of a combustor in accordance with the invention showing means for injecting a mixture of air, a substantially inert exhaust gas recycle stream and hydrocarbon fuel into the combustor to form the primary working fluid with the inert gas stream also serving as a cooling medium for the combustor;

FIG. 3 is a cross-section of the head end of the exemplary combustor design illustrated in FIG. 2, depicting in greater detail the configuration and flow pattern for air, fuel and substantially inert gas stream being fed into the combustor;

FIG. 4 is a cross-section, shown partially in perspective, of an exemplary mixing shroud for use in injecting air, fuel and an amount of exhaust gas recycle into the combustor in accordance with the invention;

FIG. 5 is a cross-section, shown partially in perspective, of a further exemplary mixing shroud for use in injecting air, EGR and fuel into the combustor; and

FIG. 6 provides two comparative block flow diagrams illustrating the basic modes of operation of the method according to the invention, namely the use of air, fuel and an inert gas flow to the combustor during start-up and shut down, as compared to such use during a stoichiometric mode of operation following startup.

### DETAILED DESCRIPTION OF THE INVENTION

The present invention includes means for injecting air directly into the combustor head end along with a significant volume of an inert gas into the combustor at particular specified locations along the exhaust flow path in order to reduce unwanted emissions, particularly CO and oxygen, while improving overall combustor performance. An exemplary system uses a specified amount of exhaust gas recycle (which is substantially inert and at a lower temperature after passing through the turbine) in an amount up to about 50% of the total combustor feed, with the remaining 50% comprising about 5% hydrocarbon fuel and 45% air. The use of an inert gas as part of the working fluid also serves to cool the combustor and reduce the combustor flame temperature while improving the stoichiometry of the gas combustion. That is, it has been found that the inert gas feed helps to establish an equivalence ratio approaching 1.0 for the fuel and oxygen fed to the combustor. Minimizing the final oxygen content in the combustor exhaust also reduces potential metallurgical damage resulting from the presence of residual oxygen in the system.

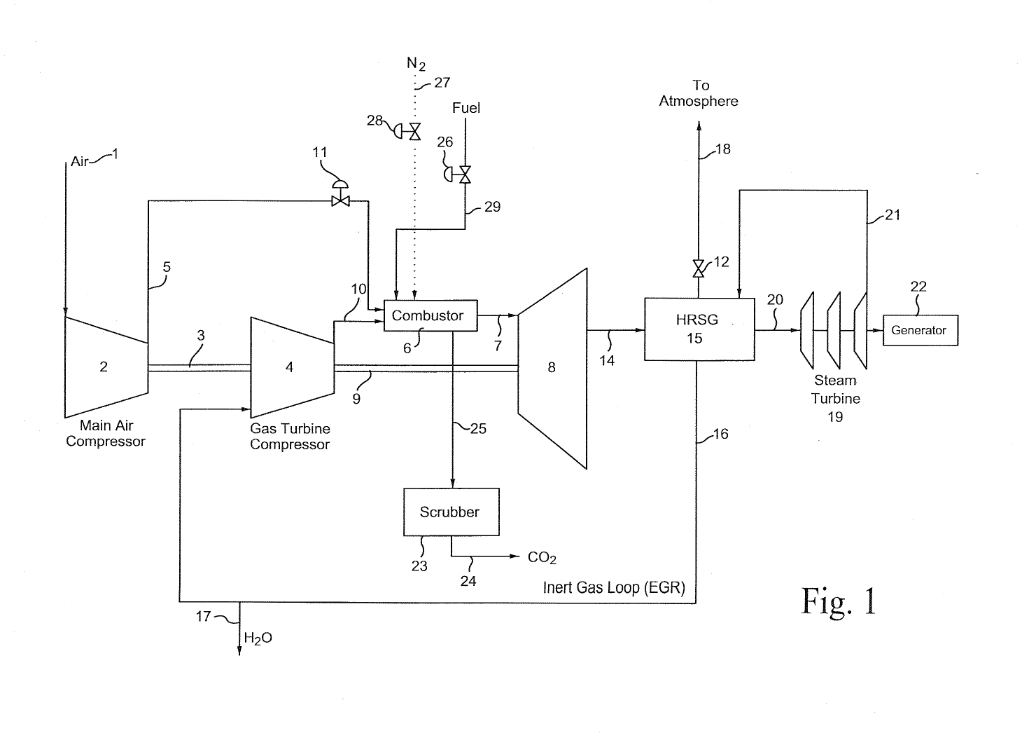

In the embodiments of FIGS. 1-6, a major component of the combustor feed is taken directly from a lower temperature gas turbine exhaust stream that is recycled back to a gas turbine compressor (but with water removed). The EGR stream passes into and out of the combustor in two different ways—first, as a feed stream into the combustor by passing the EGR through a plurality of small apertures in an exterior sleeve surrounding the combustor core; second, as a cooling medium within the same sleeve flowing in a direction opposite the core flow. The cooling EGR gas is then exhausted from the combustor through an outlet in the combustor shell. The total volume of substantially inert gas being used is approximately the same as the amount of external air entering the head end of the combustor.

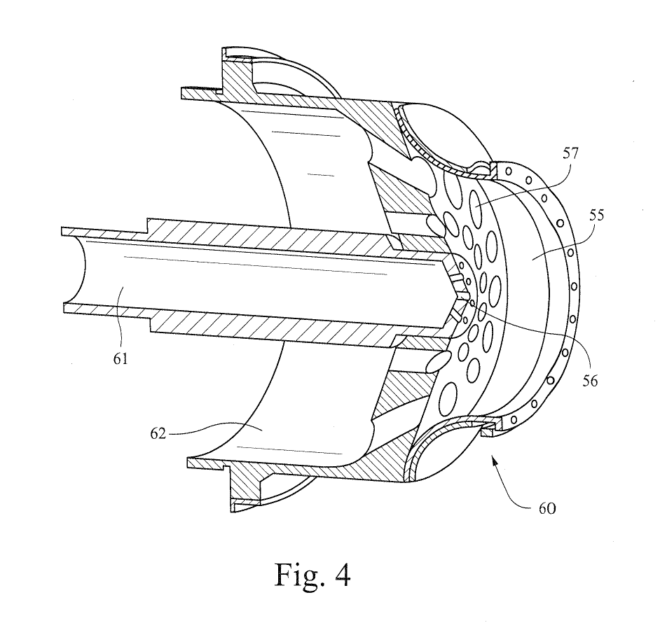

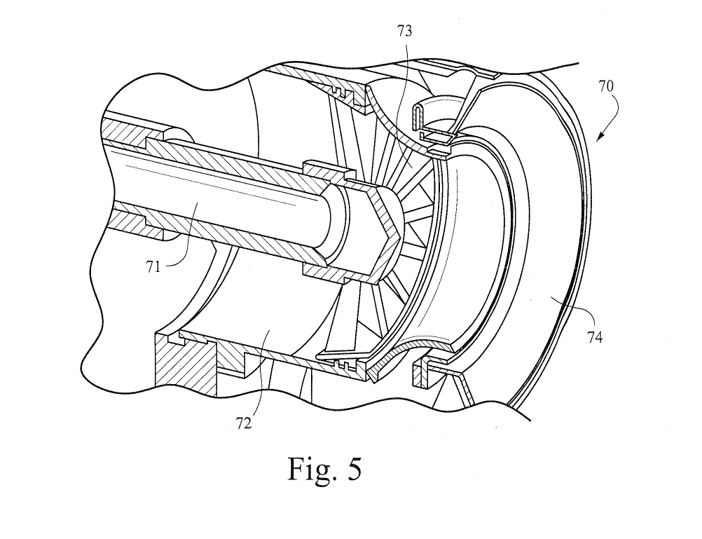

FIGS. 1-6 illustrate a number of key aspects of the invention. First, they show the injection of inert gas directly into the combustor beginning near the combustor flame and ending at a point downstream of the flame. Second, they depict the counter-current flow of the EGR in order to cool the combustor exhaust (and shell) and to help lower the flame temperature. Third, they show how the remainder of the inert gas stream is exhausted from the combustor near the head end. Finally, they illustrate the means for efficiently mixing the air, exhaust gas recycle and fuel feeds through injection nozzles specially adapted and configured to accommodate the new flow patterns as described in more detail below (see FIGS. 4 and 5).

In operation, an inert gas stream containing very little oxygen (approximately 5% of the total feed) is fed to the combustor during start-up, with the amount and volume of EGR increasing as the combustor reaches steady state operating conditions. The amount of inert gas fed to the head end of the combustor thus gradually increases over time (up to about 50%) based on the detected amount of CO and oxygen in the exhaust stream (hopefully approaching zero as the combustor continues to operate). The invention thereby achieves three benefits over conventional combustor designs: (1) lowers the residual oxygen content in the combustor exhaust to a near zero stoichiometric level; (2) helps control the composition and temperature of the combustor emissions; and (3) assists in lowering and controlling the combustor flame temperature. The low oxygen content of the final exhaust gas also helps to prevent uneven combustion (such as combustion occurring at or near the combustor wall). Further, since the cooling gases being recycled into the head end of the combustor are substantially inert, the risk of forming unwanted CO from CO₂ is much lower because less oxygen is present in the system.

FIGS. 1-6 also illustrate two exemplary nozzle configurations used to uniformly mix and distribute the air, fuel and substantially inert gas flow into the combustor, both of which allow for a maximum flow volume of air but with a low pressure drop into the nozzle upstream of the ignition point. It should be noted that the nozzle configurations shown in the figures may be adopted for use with multiple combustors having slightly different operating characteristics, fuel feeds and performance criteria.

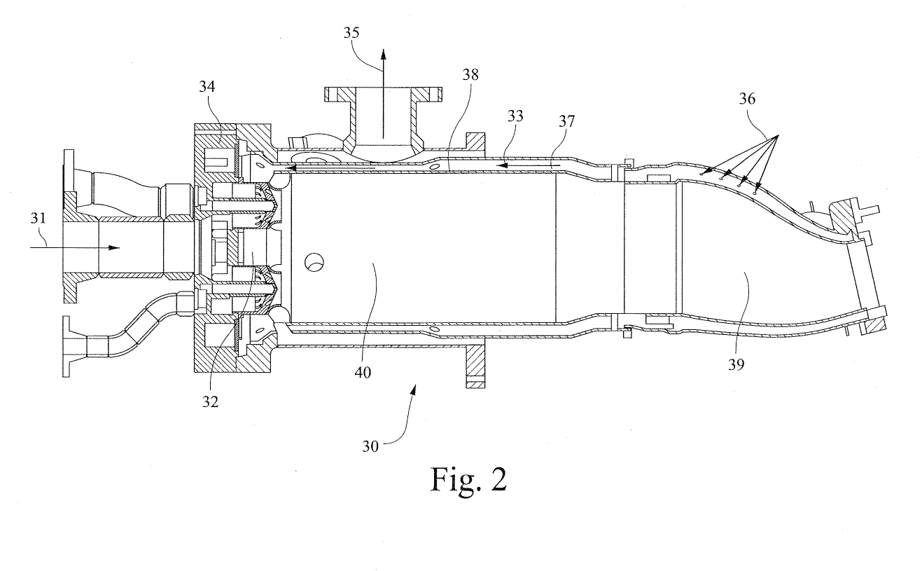

Each combustor also normally includes multiple fuel nozzles, each of which has a dedicated premixing section so that fuel is premixed with air prior to ignition in the combustion chamber. In this way, multiple dedicated premixing sections allow for the thorough premixing of fuel and air prior to being burned, a feature that assists in achieving low NOₓ, CO and O₂ levels. Typically, the plurality of diffusion/premix fuel nozzles are arranged in a circular array about the longitudinal axis of a cylindrical combustor casing, with the nozzles mounted within the combustor end cover assembly at the head end. The fuel nozzles extend into a combustor shroud with a central fuel injection port that premixes the combustion air with injected fuel as described below. See FIGS. 2-4.

The figures also illustrate the use of a cylindrical flow sleeve integral with and concentrically aligned with the cylindrical combustor shell. The flow sleeve is formed from an interior combustion liner coupled to the end cap assembly. In the exemplary embodiment of FIGS. 2-6, a flow passage is defined between the liner and outside wall of the flow sleeve. The interior wall of the flow passage includes a plurality of apertures which enable the inert gas to flow through the passages directly into the combustor chamber at locations beginning at the head end opposite the tip of the combustor flame and extending down into the combustor chamber to a point where the gases are fully combusted. The inert EGR gas flows in a direction generally opposite the direction of core flow through the combustor nozzles, i.e., towards rather than away from, the end cover assembly. As noted above, it has also been found that the performance of the combustor can be adjusted and improved by introducing a fixed volume of another diluent, such as nitrogen, into the combustor to further reduce NOₓ and/or CO emissions. The diluent can be introduced near the periphery of the fuel nozzle where it mixes with the air and fuel immediately upstream of the fuel nozzle.

Referring now to the specific figures, FIG. 1 is a process flow diagram of an exemplary gas turbine engine system illustrating the basic components and process steps for carrying out the method according to the invention as summarized above.

Controlled air feed 1 passes into a main air compressor 2 and exists at elevated pressure from the last stage of the compressor as shown at compressor exit stream into combustor 6. The main air compressor and gas turbine compressor 4 are operatively connected via rotating shaft 3 as shown. Gas turbine compressor 4 operates to drive gas turbine 8 via rotating shaft 9. The higher pressure compressor exit stream 5 leaving main air compressor 2 feeds directly into combustor 6 with the flow rate controlled using control valve 11. A controlled amount of hydrocarbon fuel 29 (such as natural gas) also feeds directly into combustor 6 through control valve 26 where it ignites and produces thermal and kinetic energy.

The spent exhaust gasses 7 exiting from the combustor drive gas turbine 8 and then pass at a lower pressure as shown at gas turbine exhaust line 14 into heat recovery steam generator (“HRSG”) 15.

The exhaust gas recirculation (“EGR”) loop 16, which comprises an inert mixture of nitrogen, CO, CO₂ and only residual amounts of oxygen, is recycled as shown back to gas turbine compressor 4 and thereafter fed at higher pressure directly into combustor 6 as shown by gas turbine feed 10. Exhaust stream 20 from HRSG 15 is used to drive steam turbine 19 to generate electrical power via generator 22 in a conventional manner. Typically, a portion of the spent exhaust from HRSG 15 will be removed from the HRSG through HRSG valve 12 and vented to the atmosphere as shown through vent line 18. In order to increase the operating efficiency of the steam turbine, the spent exhaust gasses leaving the last stage of steam turbine 19 are recycled back to the HRSG 15 via HRSG recycle line 21.

In performing the method according to the invention, substantially inert gas stream 16 (typically EGR), which is now reduced in temperature after leaving HRSG 15 and has water removed as shown at water discharge line 17, becomes part of the main feed into combustor 6 (see FIGS. 2 through 4). The EGR recycles back to gas turbine compressor 4 and then feeds at higher pressure directly into combustor 6 as described above, with the flow rate being monitored and controlled. In like manner, the flow rate of fuel to the combustor can be adjusted by control valve 26.

FIG. 1 also illustrates how the gas turbine exhaust will be treated (if necessary) to remove any final residual carbon monoxide and oxygen in the system. If the combustion step is not stoichiometrically perfect, a small amount of unburned oxygen and CO may still need to be treated in a separate operation. Here, a portion of the combustor exhaust stream 25 passes through an oxygen and hydrogen scrubber 23 which removes CO and consumes unburned free oxygen to form carbon dioxide stream 24. Alternatively, the CO scrubbing operation may comprise a catalyst bed that converts CO to carbon dioxide and consumes oxygen in an exothermic reaction. The gas turbine exhaust also passes through HRSG 15 which uses the intrinsic heat value of the exhaust gas to generate steam and extract energy via the steam turbine.

FIG. 1 also depicts the potential use of an additional diluent stream (shown in dotted line format) comprising nitrogen as part of the feed to the combustor head end, depending on the specific operating conditions of the combustor and need to further reduce the oxygen content of the combustor exhaust. Additional nitrogen diluent 27 can be introduced into the combustor as shown after passing through motor valve 28 which adjusts the flow as needed.

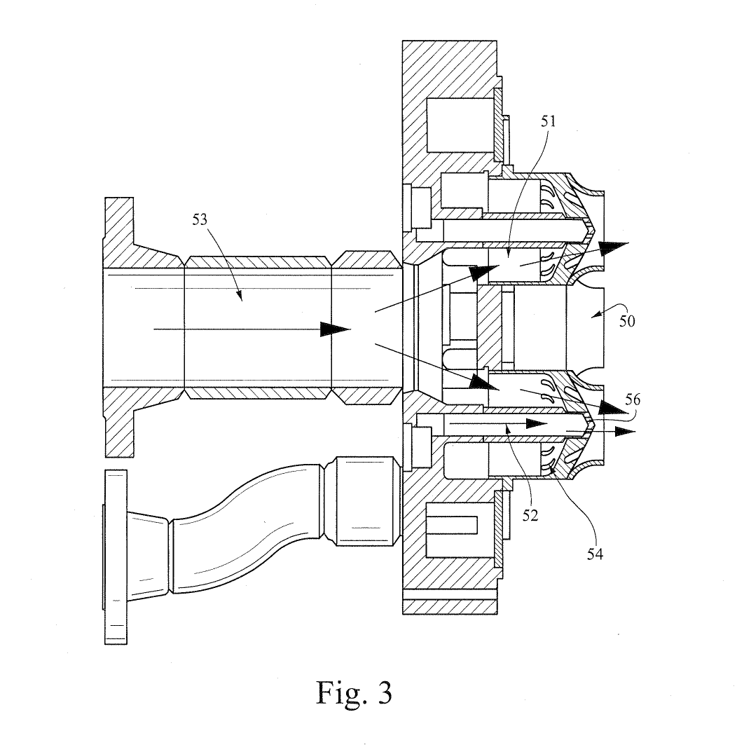

FIG. 2 is a cross-section of an exemplary embodiment of a combustor design in accordance with the invention showing means for injecting a mixture of air, a substantially inert exhaust gas stream (EGR) and hydrocarbon fuel to form the primary working fluid for the combustor, with a portion of the substantially inert gas stream also serving as a cooling medium for the combustor. Initially, during startup, the feed to combustor 30 includes air being fed directly into the combustor head end 34 as shown by air feed 31 as shown (rather than pre-mixed with fuel upstream of the combustor inlet), with a small amount of inert gas (EGR) being introduced as described above through the plurality of flow apertures 36 in the combustor shell. The air feeds directly into nozzle 32 and, after being combined with fuel as shown in FIGS. 3-5, passes into the combustor where it is ignited at fuel ignition point 40 and then passes into the lower section of the combustor at downstream combustion point 39.

Once the combustor approaches a steady state condition after the initial air and fuel feeds, the inert exhaust gas recycle stream can gradually be increased by injection into the combustor core using cylindrical flow sleeve 37 which is concentrically aligned with the combustor casing. Flow sleeve 37 includes an interior combustion liner 38 coupled to the end cap assembly which, together with the combustor exterior shell, form an EGR flow passage. The interior wall of flow sleeve 37 includes a plurality of flow apertures 36 which enable the compressed EGR gas from the gas turbine compressor (item 4 in FIG. 1) to enter and pass through the apertures directly into the combustor chamber, extending from a point opposite the combustor flame to a point generally downstream of the combustion at 39. The direction of flow inside flow sleeve 37 is opposite the direction of core flow through the combustor nozzles as described above, i.e., toward rather than away from the end cover assembly. (See flow direction arrow 33).

Thus, at one point during combustion, the substantially inert gas (EGR) performs three functions in the embodiment of FIG. 2, namely injecting inert gas directly into the combustor through the plurality of flow apertures 36; providing cooling to the lower combustor chamber, particular near the combustor wall; and helping to lower the combustor flame temperature. The portion of substantially inert gas flowing through flow sleeve 37, i.e., the gas that does not pass into the combustor core via flow apertures, is exhausted from the combustor through EGR exhaust port 35.

FIG. 3 is a cross-sectional view of the head end of a combustor design according to the invention depicting in greater detail the configuration and flow pattern for the air, fuel and substantially inert gas feeds into the combustor nozzle. Each fuel nozzle 50 includes at least one gas flow chamber 51 and one fuel chamber 52. The combined air and exhaust gas pass from gas flow chamber 51 through a plurality of injection openings 54 extending through the nozzle tip into a downstream mixing chamber (see also FIG. 5). In like manner, the fuel flow from fuel chamber 52 passes through a plurality of fuel holes 56 extending through the nozzle tip into a mixing chamber. A plurality of gas swirler holes 57 (see FIG. 4) extend through the nozzle from the outer surface of the fuel nozzle to the tip.

A separate diluent feed line, typically cylindrical, may also be included which extends around the perimeter of fuel nozzle 50 with additional flow passages sized to permit a secondary diluent flow to be included in the combined feed to the nozzle. A shroud guides the additional diluent flow toward the plurality of holes thus ensuring that a portion flow passes through the air swirler holes and into the mixing chamber where it mixes with the exhaust gas, air and fuel.

The cross-sectional view of FIG. 4, shown partially in perspective, illustrates an exemplary mixing head 60 and means for injecting air, fuel and optionally a portion of the substantially inert gas directly into the combustor. The fuel injected into the combustor passes through fuel passage 61 into a mixing zone defined by shroud 55 and combines with air passing into air manifold 62 and through the plurality of air passages as shown by way of example as gas swirler holes 57. The embodiment of FIG. 4 thus ensures that air and fuel (and possibly some additional diluent) are thoroughly mixed prior to entering the combustor upstream of the ignition point. The use of direct air injection requires that the nozzles be capable of handling a significantly increased air flow as compared to conventional combustor nozzle designs.

FIG. 5 is a further exemplary mixing head assembly 70 for use in injecting air, exhaust gas and/or substantially inert gas into the combustor in accordance with the invention. As in FIG. 4, the fuel to be injected into the combustor passes through fuel passage 71 into a fuel mixing zone defined by shroud 74 and then mixes with air passing into air manifold 72 through a plurality of vein-like air passages 73. The embodiment of FIG. 5 ensures that air and fuel (and possibly diluent) are thoroughly mixed prior to entering the combustor upstream of the ignition point.

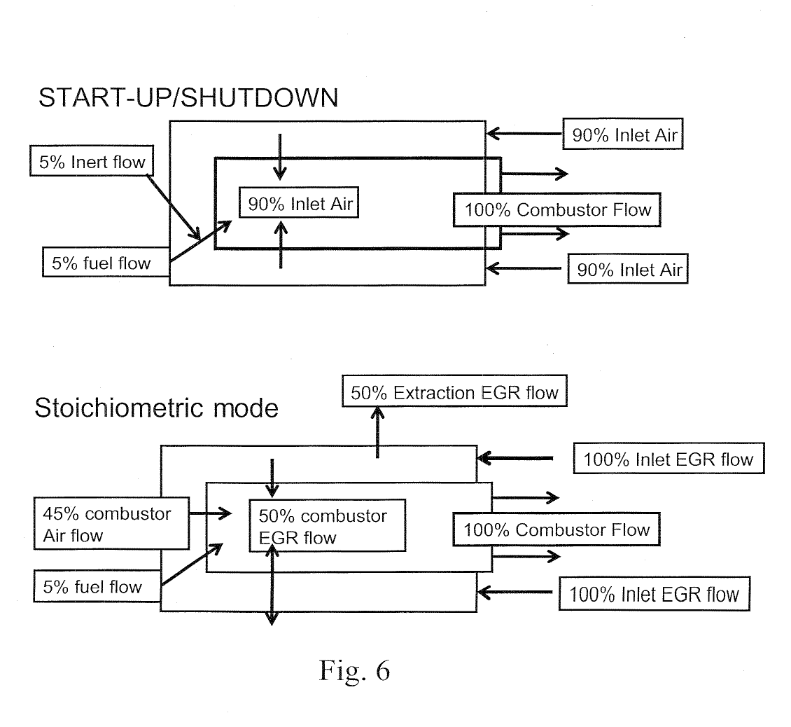

FIG. 6 includes two comparative block flow diagrams illustrating the basic modes of operation of the method according to the invention as described above, namely the use of an inert gas flows to the combustor during start-up and shut down as compared to such use during a stoichiometric mode of operation. During start-up, the amount of substantially inert gas (EGR) into the combustor is about 5% of the total flow, with 5% fuel and approximately 90% inlet air. However, as the combustor reaches steady state conditions, the amount of air flow drops to about 45%, with 5% fuel and up to about 50% of the total working fluid into the combustor comprising inert gas (EGR). The remaining 50% of the EGR flow is extracted from the combustor as shown but serves a valuable cooling function for the combustor as described above. As those skilled in the art will appreciate, it is feasible (and likely) that different combustors will reach a steady state operation under different conditions and thus the amount of air flow and EGR will vary accordingly.

While the invention has been described in connection with what is presently considered to be the most practical and preferred embodiments, it is to be understood that the invention is not to be limited to the disclosed embodiment, but on the contrary is intended to cover various modifications and equivalent arrangements included within the spirit and scope of the appended claims.

What is claimed is:

1. A method for reducing the amount of carbon monoxide and oxygen emissions in a hydrocarbon combustion system for a gas turbine engine, comprising:
(a) feeding defined amounts of a hydrocarbon fuel and oxidizer component directly into the head end of at least one combustor in said hydrocarbon combustion system;
(b) feeding defined amounts of a substantially inert gas to said combustor simultaneous with the step of feeding hydrocarbon fuel and said oxidizer component;
(c) igniting the mixture of said hydrocarbon fuel and said oxidizer component to form a combustor exhaust stream;
(d) cooling said combustor exhaust stream using a portion of said substantially inert gas to cool said combustor;
(e) detecting the amount of carbon monoxide and oxygen present in said combustor exhaust stream; and
(f) adjusting the amount of fuel, oxidizer and substantially inert gas feeds to said combustor based on the detected amount of carbon monoxide and oxygen.

2. A method according to claim 1, wherein said substantially inert gas stream comprises an exhaust gas recycle stream containing nitrogen, carbon dioxide and residual amounts of carbon monoxide and oxygen.

3. A method according to claim 1, wherein said oxidizer component comprises air.

4. A method according to claim 1, wherein said substantially inert gas stream is fed to said combustor in an amount up to 50% of said combined fuel and air feed to said combustor.

5. A method according to claim 1, further comprising the step of injecting a fixed amount of a diluent component into the head end of said combustor.

6. A method according to claim 1, further comprising the step of reducing the temperature of the exhaust gas recycle stream prior to injection into said combustor.

7. A method according to claim 1, wherein said combustion system comprises an array of multiple combustors each of which includes a combined feed stream that includes a portion of said substantially inert gas stream.

8. A method according to claim 1, wherein a substantial portion of said exhaust gas recycle stream is used to cool the combustor through injection into a flow passage integral with the combustor shell and then exhausted from said flow passage.

9. A gas turbine engine, comprising:
a gas compressor;
at least one combustor;
a turbine driven by the expanded exhaust from said combustors;
a primary fuel circuit for said combustors, said fuel circuit including means for feeding hydrocarbon fuel and air to each combustor;
means for feeding a substantially inert gas stream into said combustor;
carbon monoxide and oxygen sensors disposed in the exhaust stream of said combustors; and
control means for determining the amount of fuel, air and substantially inert gas stream to be fed to said combustor based on said detected amount of carbon monoxide and oxygen.

10. A gas turbine engine according to claim 9, further comprising an exterior flow passage integral with the shell of said combustor and sized to receive a portion of said exhaust gas recycle sufficient to cool said combustor exhaust.

11. A gas turbine engine according to claim 10, wherein said exterior flow passage includes a plurality of apertures sufficient to inject up to 50% of said exhaust gas recycle into the interior of said combustor.

12. A gas turbine engine according to claim 9, further comprising means for injecting an additional diluent material into the head end of said combustor.

13. A gas turbine engine according to claim 9, further comprising a compressor for increasing the pressure of said substantially inert gas stream prior to injection into said combustor.

14. A gas turbine engine according to claim 9, wherein additional combustors form an array of equidistant combustors disposed around a center axis, each of which having means for injecting a mixture of air, fuel and said exhaust gas recycle.

15. A gas turbine engine according to claim 9, further comprising a plurality of nozzles for injecting said air and fuel into said combustor.
